(19) United States
(12) Patent Application Publication
(10) Pub. No.: US 2008/0022937 A1
(43) Pub. Date: Jan. 31, 2008

(54) Pet Water Dish

(76) Inventors: Rob Shirley, DeLeon Springs, FL (US); Charles Peet, Ft. Lauderdale, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/776,687

(22) Filed: Jul. 12, 2007

Related U.S. Application Data
(60) Provisional application No. 60/820,382, filed on Jul. 26, 2006.

(51) Int. Cl. A01K 7/00

(52) U.S. Cl. 119/72

(57) ABSTRACT

The present invention provides an improved spill-resistant container for providing water to pets. The container generally includes a base member, annular sidewall integral with a periphery of the base member, and an annular lip extending partially inward from the sidewall forming an aperture through which the pet access the fluid (e.g., water). The base member, annular sidewall, and lip together form an inner cavity adapted to hold fluid for a pet. A circular anti-splash ring is centrally disposed within the inner cavity and extends slightly upward from the base to resist horizontal sloshing (wave action) of the fluid within the inner cavity. The anti-splash ring further includes a flow aperture, allowing fluid communication throughout the inner cavity.

This application claims priority to Ser. No. 60/820,382 filed Jul. 26, 2006, incorporated herein by reference.

### FIELD OF INVENTION

This invention relates generally to water dishes and, more particularly, to an improved water dish that deters spillage of water by limiting wave action therein.

### BACKGROUND OF INVENTION

Animals are generally provided with fluids through containers such as a simple dog dish, an old bowl or the like. Of course, these dishes and bowls are often semi-spherical in shape and, although easily filled with fluid and accessed by an animal, are prone to allowing significant splashing and spillage.

Several pet water dishes have been proposed and patented which address spillage, including U.S. Pat. Nos. 4,886,016, 5,297,504, 5,791,287, 5,881,670, 5,975,016, 6,032,824, 6,520,114, 6,912,970, D299771, U.S. Patent Application Nos. 20020166865, 20030230244, each of which are incorporated herein by reference. While these devices may be suitable for the particular purpose to which they address, they would not be as suitable for the purposes of the present invention as heretofore described.

### SUMMARY OF INVENTION

The present invention provides an improved spill-resistant container for providing water to pets. The container generally includes a base member, annular sidewall integral with a periphery of the base member, and an annular lip extending partially inward from the sidewall forming an aperture through which the pet access the fluid (e.g., water). The base member, annular sidewall, and lip together form an inner cavity adapted to hold fluid for a pet. A circular anti-splash ring is centrally disposed within the inner cavity and extends slightly upward from the base to resist horizontal sloshing (wave action) of the fluid within the inner cavity. The anti-splash ring further includes a flow aperture, allowing fluid communication throughout the inner cavity.

In accordance with the present invention, it is an object to provide an improved pet watering container that prevents spillage and resists wave action of the fluid within the container.

Another object of the instant invention is to provide a low profile watering container that resists tipping and is easily accessible by an animal.

Further objects of the invention will appear as the description proceeds.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims. Additional objects, features and advantages of the invention will become more readily apparent from the following detailed description of a preferred embodiment thereof, when taken in conjunction with the drawings.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF THE DRAWINGS

Further objects, features and advantages of the invention will become apparent from the following detailed description taken in conjunction with the accompanying figures showing a preferred embodiment of the invention, in which:

FIG. 1 is a front perspective view of the pet water dish in accordance with this invention.

FIG. 2 is a cut-away view of the pet water dish in accordance with this invention.

FIG. 3 is a top schematic view showing of the diameters of the components in accordance with this invention.

FIG. 4 is a cut-away view of the pet water dish in an alternate embodiment having a removable top.

Throughout the figures, the same reference numerals and characters, unless otherwise stated, are used to denote like features, elements, components or portions of the illustrated embodiment. Moreover, while the subject invention will now be described in detail with reference to the figures, it is done so in connection with a preferred embodiment. It is intended that changes and modifications can be made to the described embodiment without departing from the true scope and spirit of the subject invention.

### DETAILED DESCRIPTION

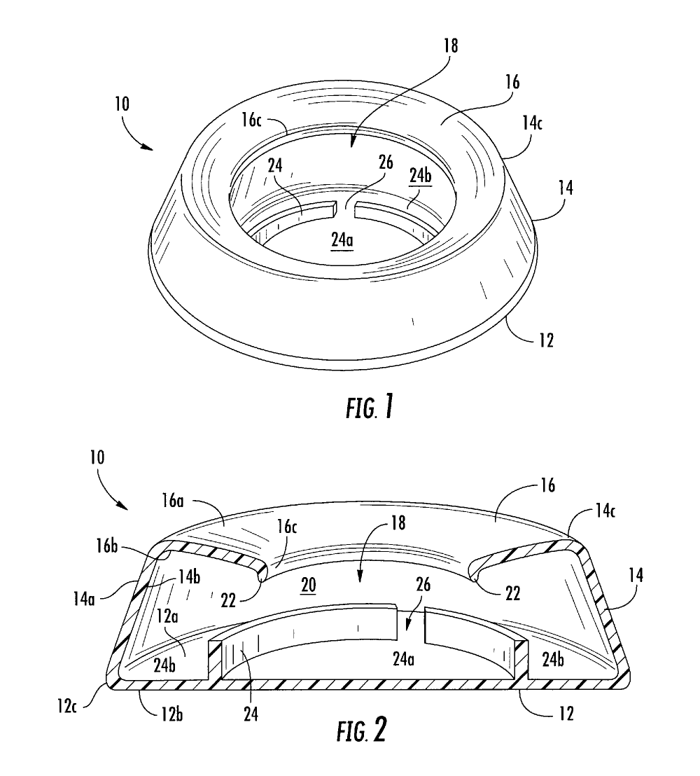

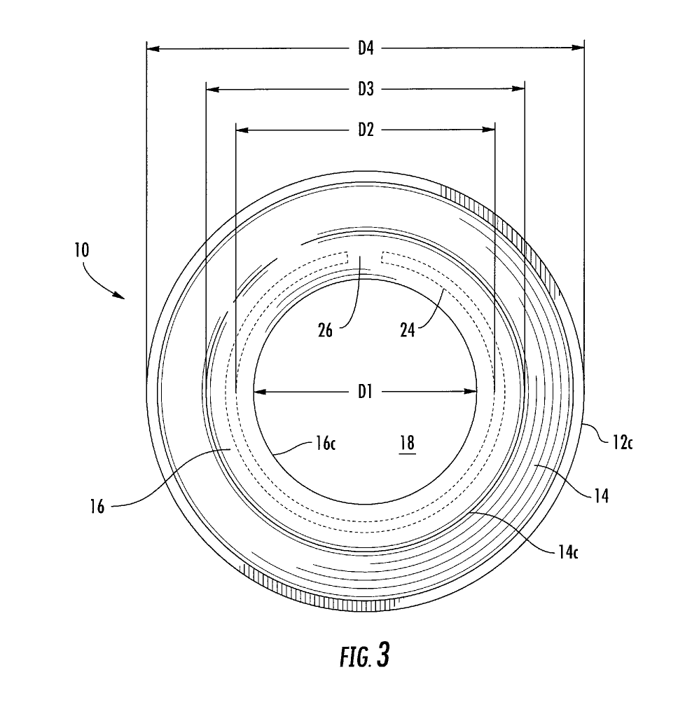

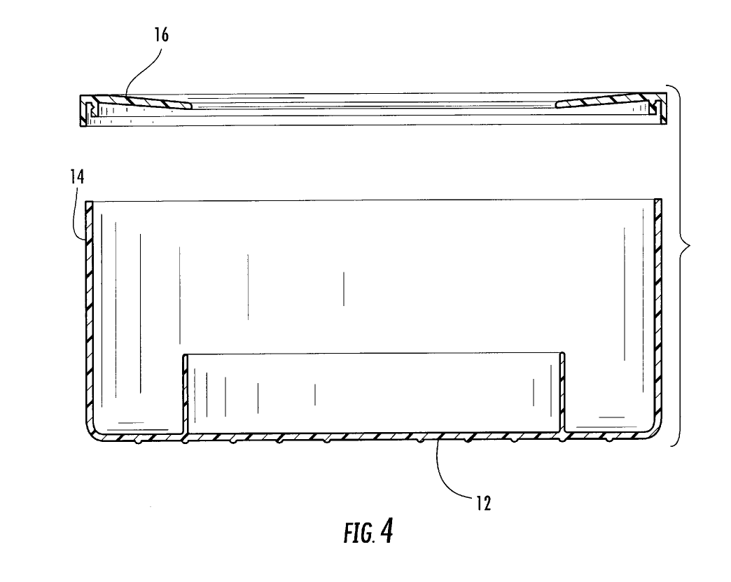

Referring to FIGS. 1-4, there is shown an improved spill-resistant container 10 for providing water to pets according to one embodiment of the present invention. The container 10 generally comprises a base member 12, annular sidewall 14 integral with a periphery of the base member, and an annular lip 16 extending partially inward from the sidewall 14 forming an aperture 18 through which the pet access the fluid (e.g., water). The base member 12, annular sidewall 14, and lip 16 together form an inner cavity 20 adapted to hold fluid for a pet.

More particularly, the support base 12 is formed from a substantially flat horizontal circular member defined by a top surface 12a, a bottom surface 12b, and a peripheral edge 12c. The peripheral edge 12c mates with corresponding annular side wall 14. The bottom surface 12b of the base 12 may employ a frictional engagement means to prevent sliding when placed upon a smooth surface. For example, frictional engagement may include grooves, raised portions, feet, applied anti-slip material, or the like.

The annular sidewall 14 is formed from a substantially vertical circular member defined by an outer surface 14a, an inner surface 14b, and an upper peripheral edge 14c. The annular sidewall 14 preferably slopes slightly inward toward upper peripheral edge 14c to help contain the fluid and resist spillage. Alternately, annular sidewall 14 may be substantially vertical as shown in FIG. 4.

Extending from the upper peripheral edge 14c of the sidewall 14, the annular lip 16 is formed from a substantially horizontal circular member defined by top surface 16a, a bottom surface 16b, and an inner peripheral edge 16c. The annular lip 16 slopes slightly downward from the upper peripheral edge 14c of the sidewall 14 to the inner peripheral edge 16c which forms the aperture 18 in a concave fashion, also to help contain the fluid, resist spillage, and direct fluid on the top surface 16a of the lip 16 back down through the aperture 18 into the inner cavity 20. Annular lip 16 may further include downwardly extending flange 22 along the inner peripheral edge 16c to help contain the fluid, resist spillage, and direct fluid splashed within the inner cavity back into the inner cavity, such as when fluid is splashed/sloshed up the inner surface 14b of the sidewall 14 to the bottom surface 16b of the annular lip 16.

In the preferred embodiment, a circular anti-splash ring 24 is centrally disposed within the inner cavity 20 on the top surface 12a of the base 12 dividing the base 12 into an inner section 24a and an outer section 24b. The anti-splash ring 24 extends slightly upward from the top surface 12a of the base 12 to resist horizontal sloshing (wave action) of the fluid within the inner cavity 20. The anti-splash ring 24 preferably has a diameter smaller than the base 12 and larger than the aperture 18. In order to allow fluids to flow between the inner section 24a and the outer section 24b when the fluid level is low, the anti-splash ring 24 includes a flow aperture 26, allowing fluid communication throughout the inner cavity 20. In this way, if water spills over into the outer section 24b, it can return to the inner section 24a through flow aperture 26 such that the animal will again have access to the fluid even when the fluid level is low.

The container 10 is preferably made from plastic, but may be made of metal, aluminum, wood, silica, rubber or other suitable material. Animal access aperture 18 is preferably round having a diameter D1 less than the diameter D2 of the anti-splash ring 24 which is less than the diameter D3 of the upper peripheral edge 14c of the annular sidewall 14 which is less than the diameter D4 of the base 12 to prevent fluid from flowing, or splashing, out of aperture 18. Other suitable shapes and dimensions are contemplated herein, including oval, free-form, or the like.

The container may be of one-piece construction or of separate pieces capable of easy assembly. For example, the lip 16 may be a separate piece, removable at any suitable attachment location, for easy cleaning. Alternately, sidewall 14 may allow for separation anywhere along its height or from the base. Base may also be removable. As shown in FIG. 4, for example, the top portion of the sidewall comprises a mating engagement to attach and remove the lip 16 from the remainder of the annular sidewall 14. The mating engagement may include, for example, a suitable tongue and groove attachment wherein one piece (such as the top) has a slot (the groove) along one edge, and the other piece (such as the sidewall) comprises a thin, deep ridge (the tongue) or edge (or vice versa). The pieces thus fit together closely. The tongue and groove could be cut in a number of ways. Any suitable attachment structures may be employed and may further include a latching/locking mechanism to latch the removable parts together. Suitable latches may range in complexity from flexible one-piece flat springs of metal or plastic, to other well-known configurations. It should be noted that for ease of manufacturing and cleaning, the components are made separable in the preferred embodiment.

It will become apparent to those skilled in the art that many changes, modifications, variations, and other uses and application of the subject invention are possible and contemplated. The use of such terms as upper, lower, and the like are intended to be descriptive of the structure as it may be oriented in use, and is not intended to be restrictive in the claims to that orientation. It should be understood that the invention has application far beyond the exemplary embodiments presented and described herein, and as such is not to be limited to those embodiments. In addition, the invention is not limited to the particularly physical configuration, but instead is adaptable. All changes, modifications, variations, and other uses and applications which do not depart from the spirit and scope of the invention are deemed to be covered by the invention.

1. A pet water dish for holding a liquid therein and resisting spillage comprising:
a base member;
an annular sidewall, having a top edge and a bottom edge, the bottom edge joined at or near a periphery of the base member, and
an annular lip extending partially radially inward from the top edge of the sidewall leaving an access aperture through which the pet can access an inner cavity adapted to hold a liquid;
an anti-splash ring disposed within the inner cavity radially inward from the annular sidewall and extending slightly upward from the base to resist horizontal wave action of the liquid within the inner cavity; and
a flow aperture in the anti-splash ring for allowing liquid communication throughout the inner cavity.

2. The pet water dish of claim 1 wherein the base member comprises a substantially flat horizontal circular member defined by a top surface, a bottom surface, and a peripheral edge, wherein the peripheral edge mates with the bottom edge of the annular side wall.

3. The pet water dish of claim 2 wherein the peripheral edge is integral with the bottom edge of the annular sidewall.

4. The pet water dish of claim 2 wherein the bottom surface of the base includes frictional engagement to prevent sliding when placed upon a smooth surface.

5. The pet water dish of claim 1 wherein the annular sidewall comprises a substantially vertical circular member defined by an outer surface, an inner surface, and a top edge and a bottom edge.

6. The pet water dish of claim 5 wherein the annular sidewall slopes inward toward the top edge to help contain the fluid and resist spillage.

7. The pet water dish of claim 1 wherein the annular lip comprises a substantially horizontal circular member defined by top surface, a bottom surface, and an inner peripheral edge defining the access aperture through which the pet can access the inner cavity.

8. The pet water dish of claim 7 wherein the annular lip slopes slightly downward and radially inward from the top edge of the sidewall to the inner peripheral edge defining the access aperture in a concave fashion, thereby helping to contain the liquid, resist spillage, and direct liquid on the top surface of the annular lip back down through the access aperture into the inner cavity.

9. The pet water dish of claim 8 wherein the annular lip further comprises a downwardly extending flange along the inner peripheral edge, thereby helping to contain the liquid, resist spillage, and direct liquid splashed within the inner cavity back into the inner cavity.

10. The pet water dish of claim 1 wherein the anti-splash ring is centrally disposed within the inner cavity on a top surface of the base dividing the base into an inner section and an outer section so that the flow aperture allows liquid communication between the inner section and an outer section.

11. The pet water dish of claim 10 wherein the anti-splash ring comprises a diameter smaller than a diameter of the base and larger than a diameter of the access aperture.

12. The pet water dish of claim of claim 1 wherein the anti-splash ring is in the form of a vertical wall.

13. The pet water dish of claim of claim 1 wherein the anti-splash ring extends slightly upward and slopes slightly radially inward or radially outward.

14. The pet water dish of claim 1 wherein the overall shape of the base, sidewall, lip, access aperture, and anti-splash ring are correspondingly circular, oval, square, rectangle or free-form.

15. The pet water dish of claim 1 wherein the base, sidewall, lip, and anti-splash ring are of one-piece construction.

16. The pet water dish of claim 1 wherein one or more of the base, sidewall, lip, and anti-splash ring are separable pieces capable of assembly and disassembly for easy cleaning.

17. The pet water dish of claim 1 comprising one or more flow apertures in the anti-splash ring.

18. A pet water dish for holding a liquid therein and resisting spillage comprising:
a substantially flat base member;
an annular sidewall, having a top edge and a bottom edge, the bottom edge joined at or near a periphery of the base member, wherein the annular sidewall slopes inward toward the top edge to help contain the fluid and resist spillage;
an annular lip extending partially radially inward from the top edge of the sidewall leaving an access aperture through which the pet can access an inner cavity adapted to hold a liquid, wherein the annular lip slopes slightly downward and radially inward from the top edge of the sidewall to an inner peripheral edge defining the access aperture in a concave fashion, thereby helping to contain the liquid, resist spillage, and direct liquid on the top surface of the annular lip back down through the access aperture into the inner cavity;
an anti-splash ring disposed within the inner cavity radially inward from the annular sidewall having a diameter smaller than a diameter of the base and larger than a diameter of the access aperture and extending slightly upward from the base dividing the base into an inner section and an outer section, the anti-splash ring formed to resist horizontal wave action of the liquid within the inner cavity; and
a flow aperture in the anti-splash ring for allowing liquid communication throughout the inner cavity between the inner section and the outer section.
